(19) United States
(12) Patent Application Publication
(10) Pub. No.: US 2018/0027765 A1
(43) Pub. Date: Feb. 1, 2018

(54) Button and Applicator for Animal Identification Tags

(71) Applicant: Cattle Time, LLC, Atlanta, GA (US)

(72) Inventors: Alan Butler, Atlanta, GA (US); Daniel Budenstein, Atlanta, GA (US); Xerxes Clayton, Suwanee, GA (US); Cameron Davis, Los Angeles, CA (US); Tyler French, Macon, GA (US); Garrett Meyer, Columbus, GA (US); Cheryl Teo, Novi, MI (US)

(21) Appl. No.: 15/662,501

(22) Filed: Jul. 28, 2017

Related U.S. Application Data
(60) Provisional application No. 62/368,246, filed on Jul. 29, 2016.

(51) Int. Cl. A01K 11/00; G09F 3/08

(52) U.S. Cl. CPC A01K 11/002; A01K 11/004; G09F 3/08

(57) ABSTRACT

Systems, methods, and devices directed to a button and corresponding applicator for an animal identification tag are provided. The applicator is employed to attach a button-tag assembly to the ear of an animal. The button includes a solid core embedded in the body of the button as well as a bladed edge at the tip of the core.

### CROSS-REFERENCE TO RELATED PATENT APPLICATION

This application claims the benefit of U.S. Provisional Patent Application No. 62/368,246 entitled “Button and Applicator for Animal Identification Tags” and filed on Jul. 29, 2016 which is incorporated by reference herein in its entirety.

### BACKGROUND

In the field of animal husbandry, animals are often identified by tags that include a unique identification number and which are often attached to the ear of the animal. Occasionally, tags are lost due to a variety of factors relating to, e.g., environmental conditions, the behavior of the animal, and the properties of the tag itself. For example, prolonged exposure to ultraviolet (UV) radiation and continually changing temperatures can cause the material of some identification tags to degrade and crack. As a result, degraded identification tags can fail and, in turn, fall off. Some identification tags may also degrade and fail as a result of repeated rubbing against objects in the surrounding environment such as, e.g., trees, fences, bushes, and the like. Furthermore, some identification tags can become snagged and thus be torn off.

Therefore, there is a need for improved animal identification tags that increase the retentions rate of such tags once attached.

### BRIEF DESCRIPTION OF THE DRAWINGS

Aspects of various embodiments are illustrated by way of example, and not by way of limitation, in the figures of the accompanying drawings. One or more components illustrated in the accompanying figures may be positioned in other than the disclosed arrangement and that one or more of the components illustrated may be optional. The drawings may represent the scale of different components of one embodiment; however, the disclosed embodiment is not limited to that particular scale.

FIG. 1 depicts a schematic diagram of an example of an implementation of a button for an animal identification tag in accordance with aspects of the present disclosure.

FIG. 2 depicts a top perspective view of an example of an implementation of a button for an animal identification tag in accordance with aspects of the present disclosure.

FIG. 3 depicts a side cross-sectional view of the button of FIG. 2.

FIG. 4 depicts a side cross-sectional view of a mid-region of the button of FIG. 2.

FIG. 5 depicts a side cross-sectional view of a front region of the button of FIG. 2.

FIG. 6 depicts a top perspective view of the button core of the button of FIG. 2.

FIG. 7 depicts a pair of side views of the button of FIG. 2 with example dimensions for portions of the button.

FIG. 8 depicts a top view and a top perspective view of the button of FIG. 2.

FIG. 9 depicts an example of an implementation of a button applicator in accordance with aspects of the present disclosure.

FIG. 10 depicts a top perspective view of the button holder of the button application of FIG. 9.

FIG. 11 depicts various perspective views of the button applicator of FIG. 9 and its components.

FIG. 12A depicts the button applicator of FIG. 9 configured with an example button and an example identification tag in example use.

FIG. 12B depicts example operation of the button applicator of FIG. 9.

FIG. 12C depicts an example of an implementation of a button assembly formed with the button applicator of FIG. 9.

FIG. 13A depicts a top perspective view of an example of an implementation of a button mold assembly in an exploded configuration and in accordance with aspects described herein.

FIG. 13B depicts a top perspective view of a mold assembly portion of the button mold assembly of FIG. 13A.

FIG. 13C depicts a front view of a mold assembly portion of the button mold assembly of FIG. 13A.

FIG. 14 depicts a front view of a mold cavity of a mold assembly portion of the button mold assembly of FIG. 13A.

FIG. 15 depicts a first stress analysis diagram for the button of FIG. 2 without the button core.

FIG. 16 depicts a second stress analysis diagram for the button of FIG. 2 without the button core.

FIG. 17 depicts a third stress analysis diagram for the button of FIG. 2 without the button core.

FIG. 18 depicts a stress analysis diagram for the button of FIG. 2 with the button core.

FIG. 19 depicts a set of designs for a button head of a button for an animal identification tag in accordance with aspects described herein.

FIG. 20 depicts a set of designs for a button back of a button for an animal identification tag in accordance with aspects described herein.

FIG. 21 depicts a set of designs for a button shaft of a button for an animal identification tag in accordance with aspects described herein.

FIG. 22 depicts a set of designs for a button core void of a button for an animal identification tag in accordance with aspects described herein.

### DETAILED DESCRIPTION

Aspects of the present disclosure are directed to a button configured to attach an identification tag to the ear of an animal and an applicator configured to perform the attachment.

Aspects of the button described herein are designed to improve the retention rate of an attached identification tag by reducing the likelihood that the button will fail resulting in loss of the identification tag. For example, aspects of the button promote resistance to degradation from, e.g., UV radiation, temperature changes, hydrolysis, and the like. In addition, aspects of the button promote the release of the button from a snag or other encumbrance without damaging or otherwise degrading the button. Furthermore, aspects of the button promote faster healing and lower rates of infection which, in turn, result in less irritation to the animal and thus less disturbance by the animal at the attachment site, e.g., by rubbing, scratching, and the like. Additional advantages will be appreciated upon review of the additional disclosures set forth in further detail below.

While embodiments may be implemented in many different forms, there are shown in the drawings and will herein be described in detail various example embodiments with the understanding that the present disclosure is to be considered as an exemplification of the principles disclosed herein and is not intended to limit the broad aspects of those principles to the embodiments illustrated. Other embodiments may be utilized, and structural and functional modifications may be made, without departing from the scope and spirit of the present disclosure.

In the following description of various example structures, reference is made to the accompanying drawings which are shown by way of illustration various example components, devices, systems, and environments in which aspects of the disclosure may be practiced. Other specific arrangements of example components, devices, systems, and environments may be utilized, and structural and functional modifications may be made without departing from the scope of the present disclosure.

Also, while the terms “top,” “bottom,” “upper,” “lower,” “front,” “back,” “side,” “rear,” “forward,” “backward,” “upward,” “downward,” “rearward,” and the like may be used herein to describe various features and elements of the example embodiments, these terms are used herein as a matter of convenience, e.g., based on the example orientations shown in the figures or the orientation during example use. Additionally, the term “plurality,” as used herein, indicates any number greater than one, either disjunctively or conjunctively, as necessary, up to an infinite number. Furthermore, the term “set,” as used herein, indicates a collection of one or more elements. Nothing in the disclosures below should be construed as requiring a specific three dimensional orientation of structures in order to fall within the scope of those disclosures. Finally, unless explicitly indicated, the attached drawings are not necessarily drawn to scale and any dimensions are provided by way of example only.

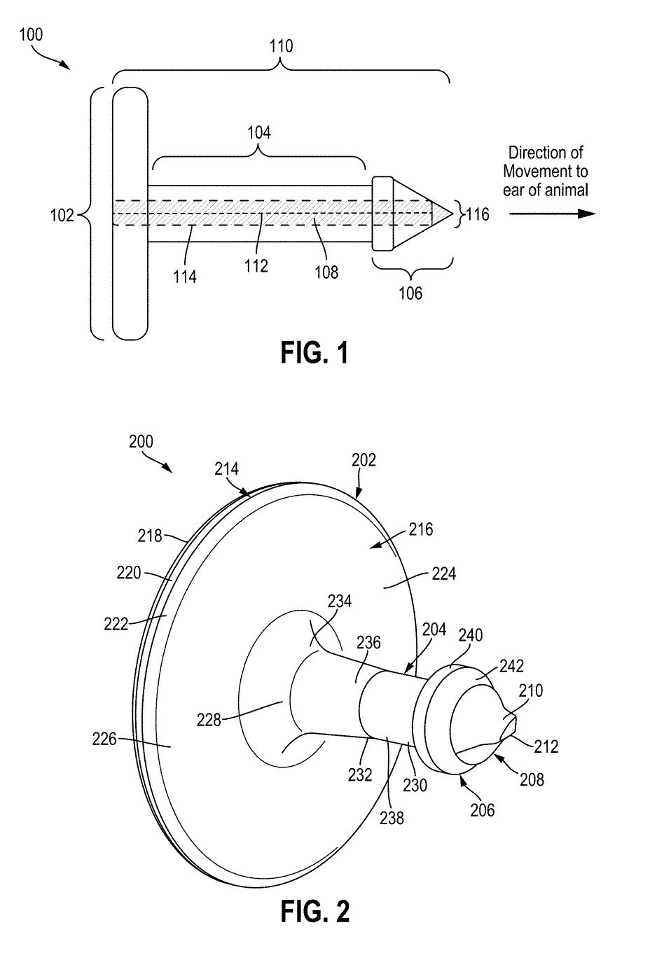

FIG. 1 depicts a schematic diagram of an example of an implementation of a button 100 for an animal identification tag in accordance with aspects of the present disclosure. The button 100 in this example includes a button back 102, a button shaft 104, a button head 106, and a button core 108. The button back 102, button shaft 104, and button head 106 may be described as making up the body 110 of the button 100. The button shaft 104 extends along the longitudinal axis 112 of the button 100 and connects the button back 102 to the button head 106. A void 114 extends through the button 100 along the longitudinal axis 112 through each of the button back 102, the button shaft 104, and the button head 106. The button core 108 resides within the void 114 such that the core may be described as embedded in the button body 110. The button core 108 residing within the void 114 also extends through the button 100 along the longitudinal axis 112 through each of the button back 102, the button shaft 104, and the button head 106. With the button core 108 embedded in the button body 110, the button is substantially free of any voids in an assembled configuration. The button core 108 also includes a core tip 116 that protrudes from the button head 106. As described in further detail below, the core tip 116 is shaped so as to make a hole in the ear of an animal when applying an identification tag.

For the sake of clarity, the following terminology is adopted to facilitate the description of the button 100 and its features. The portion of the button 100 that includes the button back 102 is referred to herein as the proximal end of the button, and the portion of the button that includes the button head 106 is referred to herein as the distal end of the button. The button 100 has a length that is measured along its longitudinal axis 112 between the proximal end and distal end of the button. The button 100 has a width that is measured along an axis that is perpendicular to the longitudinal axis 112. The button 100 has an overall length as well as an overall width. The overall length is measured from the rear surface of the button back 102 to the end of the core tip 116. The overall width of the button 100 is measured across the button at its widest point. As described in further detail below, various aspects of the button 100 have individual lengths and widths. Accordingly, various implementations of a button may exhibit different lengths and/or widths while remaining within the scope of the claimed subject matter. Additionally, the button 100 and various portions or regions of the button may be described as having a thickness which may be measured along one or more axes of the button, e.g., the longitudinal axis 112 of the button, an axis perpendicular to the longitudinal axis, and/or an axis oblique to the longitudinal axis.

FIG. 2 depicts a top perspective view of an example of an implementation of a button 200 for an animal identification tag in accordance with aspects of the present disclosure. The button 200 shown by way of example in FIG. 2 likewise includes a button back 202 connected to a button shaft 204 which is in turn connected to a button head 206. The button back 202, button shaft 204, and button head 206 of the button 200 in FIG. 2 has a singular, one-piece construction such that the material forming the button back, button shaft, and button head is contiguous. As described in further detail below, the button back 202, button shaft 204, and button head 206 may be constructed using injection molding techniques.

A button core 208 is embedded in the button 200 such that the core extends through at least a portion of the button shaft 204 and the button head 206. In some example implementations, the button core 208 may extend through the entirety of the button back 202, the button shaft 204, and the button head 206. In other example implementations, the button core 208 may extend through only a portion of the button back 202 and/or only a portion of the button shaft 204. The button core 208 includes a core head 210 that protrudes from the button head 206 of the button 200. Accordingly, in some example implementations, the core head 210 may be the only portion of the button core 208 that is visible from the exterior of the button 200.

The core head 210 in FIG. 2 includes a bladed edge 212 that makes an incision at the ear of an animal when applying an identification tag. In other example implementations, the core head 210 may include a pointed tip that punctures the ear of an animal when applying an identification tag. In certain applications, incising the ear using a button having a core with a bladed edge may be preferred over puncturing the ear using a button having a core with a pointed tip. This is because an incision may heal faster than a puncture. In addition, an incision can be less prone to infection than a puncture and, as a result, be less irritating to the animal. Less irritation may result in less scratching, rubbing, and the like by the animal thus reducing disturbance to the identification tag and/or button. Although a core having a bladed edge may be preferred in certain circumstances, a core having a pointed tip may be used without departing from the scope of the claimed subject matter.

The button core 208 in FIG. 2 is constructed from a metallic material. Various types of metallic material may be used to construct the button core 208 including, for example, aluminum and aluminum alloys, copper and copper alloys (e.g., brass, bronze), iron and iron alloys (e.g., steel, stainless steel), lead and lead alloys (e.g., solder), nickel and nickel alloys, silver and silver alloys, gold and gold alloys, titanium and titanium alloys, tin and tin alloys, tungsten and tungsten alloys, palladium, and other types of metallic materials that reinforce and promote the structural integrity of a button for an identification tag when embedded in that button. In some example implementations, 12-gage 430 stainless steel wire may be selectively employed to form the button core 208 (e.g., part number 89065K24 from McMaster-Carr Supply Company of Elmhurst, Ill.). In example implementations the metallic material used to construct the button core 208 may be magnetic (e.g., paramagnetic or ferromagnetic), while in other implementations the core may be non-magnetic. In other implementations, the button core 208 may be constructed of non-metallic materials that nevertheless reinforce and promote the structural integrity of the button 200 for an identification tag when embedded in the button. Examples of non-metallic materials that may be used to construct the core include high-strength resins, high-strength polymers, high-strength polyresins, high-strength composite materials, and the like.

The button back 202 in FIG. 2 is substantially flat, has a circular shape, and includes a curved edge 214 and a flange 216. The button shaft 204 of the button 200 in this example is connected to the button back 202 at the center of the button back. The curved edge 214 of the button back 202 in this example includes multiple curved edge portions 218-222 each having an individual radius of curvature. In particular, the curved edge 214 in FIG. 2 includes a 1^{st} curved edge portion 218 having a 1^{st} radius of curvature, a 2^{nd} curved edge portion 220 having a 2^{nd} radius of curvature, and a 3^{rd} curved edge portion 222 having a 3^{rd} radius of curvature. In some example implementations, each radii of curvature may be different while in other example implementations, two or more of the radii of curvature may be the same. The flange 216 of the button back 202 in this example includes a front surface 224 that faces toward the distal end of the button 200. The front surface 224 of the flange 216 includes a circumferential flat region 226 extending from the curved edge 214 toward the center of the button back 202 where it connects to a filleted rear shaft portion which will be discussed in further detail below.

While the button back 202 shown by way of example in FIG. 2 exhibits a circular shape (i.e., has a circular cross-sectional shape), other shapes may be employed for the button back. For example, in other implementations a button back may exhibit a triangular shape, a square shape, a rectangular shape, a pentagonal shape, a hexagonal shape, a heptagonal shape, an octagonal shape, a rhomboid shape, a kite shape, a trapezoidal shape, an oval shape, a star shape, and other types of shapes. The shape of a button back may be a regular shape or an irregular shape. In another example, the shape of a button back may conform to the shape of a numeric character (e.g., 0-9), an alphabetic character (e.g., A-Z, a-z), or a symbol, emblem, or icon (e.g., a heart, a spade, a sun, a moon). In a further example, the shape of a button back may be amorphous. The shape of the flange 216 may determine the manner in which and the extent to which the flange flexes when disturbed, e.g., when scratched, rubbed, pulled, etc.

In addition, in some example implementations, a flange of a button may include a non-flat region extending from the edge of the button back toward the center. For example, instead of a flat region, some example implementations of a button may include a flange having a concave region extending from the edge toward the center, a convex region extending from the edge toward the center, or an incline region extending from the edge toward the center in which a height of the incline region proximate the edge is less than a height of the incline region proximate the center.

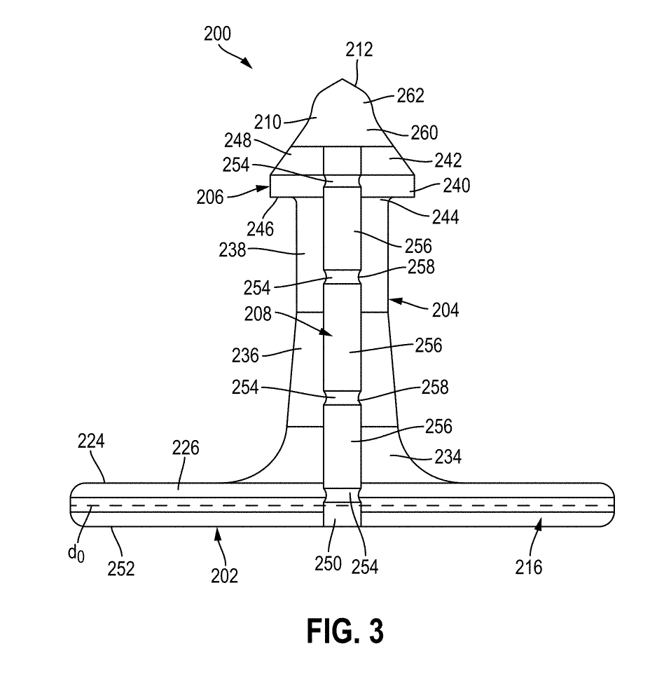

As noted above, the button shaft 204 of the button 200 in FIG. 2 is positioned at the center of the button back 202 and extends away from the button back toward the distal end of the button. The button head 206 is connected to the button shaft 204 at the distal end of the button. Accordingly, the button shaft 204 in this example may be described as having a shaft rear region 228 proximate to the button back 202, a shaft front region 230 proximate to the button head 206, and a shaft middle region 232 between the shaft rear region and the shaft front region. The button shaft 204 in FIG. 2 includes a filleted rear shaft portion 234, a conical shaft portion 236, a cylindrical shaft portion 238, and a filleted front shaft portion (shown in FIG. 3). The filleted rear shaft portion 234 provides a smooth transition from the flat region 226 of the flange 216 to the rest of the button shaft 204 that extends away from the flange thereby distributing across the filleted rear shaft portion any stress the button shaft might experience. The conical shaft portion 236 extends from the filleted rear shaft portion 234 toward the shaft middle region 232 where it connects to the cylindrical shaft portion 238. The conical shaft portion 236 in this example tapers from the shaft rear region 228 toward the shaft middle region 232. In other words, the width of the conical shaft portion 236 proximate to the shaft rear region 228 is greater than the width of the conical shaft portion proximate to the shaft middle region 232. The cylindrical shaft portion 238 extends from the shaft middle region 232 toward the shaft front region 230 and connects to the filleted front shaft portion. Although not shown in FIG. 2, the filleted front shaft portion is positioned between the cylindrical shaft portion 238 and the button head 206. The filleted front shaft portion likewise provides a smooth transition from the cylindrical shaft portion 238 to the rear surface of the button head 206 and likewise distributes across the filleted front shaft portion any stress the button head might experience. The filleted front shaft portion of the button shaft 204 and the rear surface of the button head 206 are shown in FIG. 3.

The button head 206 of the button 200 in FIG. 2 includes a cylindrical head portion 240 and a conical head portion 242. The cylindrical head portion 240 is positioned proximate the filleted front shaft portion and extends away from the filleted front shaft portion toward the conical head portion 242. The conical head portion 242 extends away from the cylindrical head portion 240 toward the core head 210. The conical head portion 242 also tapers toward the core head 210 such that a width of the conical head portion proximate to the cylindrical head portion 240 is greater than a width of the conical head portion proximate to the core head.

As described in further detail below, the button back, button shaft, and button head of a button may be constructed using mold injection techniques. Various types of materials may be selectively employed to form the button back, button shaft, and button head. For example, in some implementations, a thermoplastic elastomer may be used to form the button back, button shaft, and button head. To reduce the likelihood of failure, a thermoplastic elastomer that is heat-stabilized and UV-stabilized may be selected. In addition, the thermoplastic elastomer may include a mold release additive to help release the button from the mold during the injection molding process described below. To avoid infection, a material having anti-microbial properties may be selected.

Furthermore, the thermoplastic elastomer selected may have the following properties in some example implementations: a density of about 1.00 g/cm³ according to the ISO 1183 test method; a water absorption at equilibrium (20° C. and 50% R.H.) of about 0.4% according to the ISO 62 test method; a water absorption (23° C. and 24 hours in water) of about 1.2% according to the ISO 62 test method; a melting point of about 134° C. according to the ISO 11357 test method; a vicat point (under 1 daN) of about 58° C. according to the ISO 306 test method; shrinkage (after 24 hours, 4 mm, mold at 40° C.) of about 0.5% (//) and about 0.8% (⊥) according to the internal test method; an instantaneous hardness (after 15 days at 23° and 50% R.H.) of about 77/27 Shore A/Shore D according to the ISO 868 test method; a hardness after 15 seconds (after 15 days at 23° and 50% R.H.) of about 74/22 Shore A/Shore D according to the ISO 868 test method; a tensile stress at break (after 15 days at 23° and 50% R.H.) of about 32 MPa according to the ISO 527 test method; a tensile strain at break of greater than about 750% according to the ISO 527 test method; a flexural modulus (after 15 days at 23° and 50% R.H.) of about 12 MPa according to the ISO 178 test method; and exhibit no break during a Charpy impact test (after 15 days at 23° and 50% R.H.) at 23° C. and −30° C. when unnotched and when V-notched according to the ISO 179 test. In some example implementations the thermoplastic elastomer may be a polyether block amide such as PEBAX® available from Arkema of Colombes, France. In some example implementations, PEBAX® 2533 SD 02 may be selectively utilized to form the button back, button shaft, and button head.

The material selected may additionally or alternatively have the following properties: a glass transition temperature of less than about −20° C.; an outer layer tensile modulus of between about 4,000 pounds per square inch (psi) to about 6,500 psi; and a core tensile modulus of greater than about 40,000 psi.

FIG. 3 depicts a side cross-sectional view of the button of FIG. 2. The cross-sectional view of the button 200 in FIG. 3 depicts additional features of the button. As described above with reference to FIG. 2, the button back 202 includes a flange 216 which the button shaft 204 is connected to. The button shaft 204 includes a filleted rear shaft portion 234 connected to the front surface 224 of the flange 216. The filleted rear shaft portion 234 extends away from the front surface 224 of the flange 216 toward the conical shaft portion 236 of the button shaft 204. The conical shaft portion 236 extends away from the filleted rear shaft portion 234 toward the cylindrical shaft portion 238 of the button shaft 204. The conical shaft portion 236 also tapers toward the cylindrical shaft portion 238 of the button shaft 204. The cylindrical shaft portion 238 extends away from conical shaft portion 236 toward the filleted front shaft portion 244 of the button shaft 204. The filleted front shaft portion 244 is connected to the rear surface 246 of the button head 206. The button head 206 includes a cylindrical head portion 240 extending away from the filleted front shaft portion 244 of the button shaft 204 toward a conical head portion 242 of the button head. The conical head portion 242 extends away from the cylindrical head portion 240 toward the core head 210 of the button core 208. The conical head portion 242 also tapers toward the core head 210 of the button core 208. The front surface 248 of the button head 206 in this example includes the surface of the conical head portion 242.

As seen in FIG. 3, the button core 208 is embedded in the button 200 such that the button is substantially free of any voids in its assembled configuration. The button core 208 in this example extends through each of the button back 202, the button shaft 204, and the button head 206 and includes a core head 210 that protrudes from the button head 206. The button core 208, in this example, is a full tang button core and also includes a core end 250 embedded in the button back 202 that is flush with the rear surface 252 of the button back. The button core 208 in this example also includes a series of circumferential grooves 254 that help to secure the button core within the button 200. The grooves 254 increase the surface area of the button core 208 thereby providing a larger area for the surrounding material to bind to. Additional and alternative techniques may be selectively employed to increase the surface area of a button core and thereby promote bonding between the outer surface of the button core and the surrounding material. In example implementations, the outer surface of a button core may include one or more features to promote bonding of the button core and the surrounding material. For example, the outer surface of a button core may be roughened using various techniques to promote bonding between the button core and the polymer. For example, the outer surface of a button core may be sand-blasted, filed, mechanically etched, chemically etched, chemically treated, threaded, ground, scraped, knurled, and the like in order to form various types of structures on the outer surface on the button core that promote bonding with the surrounding material. Examples of such structures include threads, pores, channels, etchings, knurls, cavities, notches, and the like. As seen in FIG. 3, the circumferential grooves 254 divide the button core 208 into a series of cylindrical core body portions 256 and each groove exhibits an arcuate contour 258. The core head 210 of the button core 208 in this example includes a linearly tapering region 260 and a non-linearly tapering region 262. The linearly tapering region 260 of the core head 210 extends away from the conical head portion 242 of the button head 206 toward the non-linearly tapering region 262 of the core head. The non-linearly tapering region 262 of the core head extends away from the linearly tapering region 260 toward the bladed edge 212 of the core head 210. The linearly tapering region 260 and a non-linearly tapering region 262 of the core head 210 will be discussed in further detail below.

As noted above, the button 200 may exhibit different widths at various points along the button. For example, the button 200 is widest across the width of the button back 202 which is identified in FIG. 3 as diameter, d₀. Accordingly, diameter, d₀, corresponds to the overall width of the button 200 in this example.

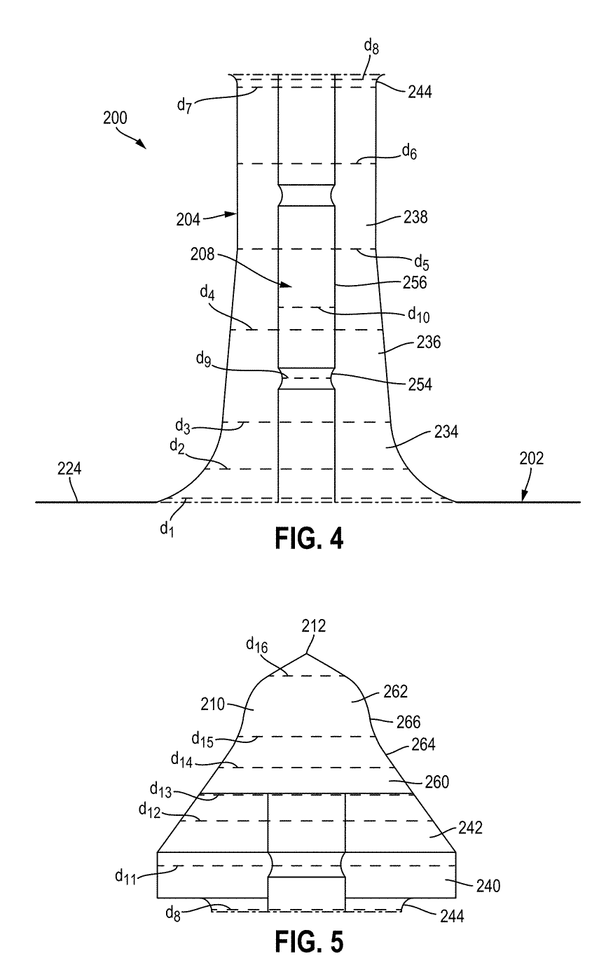

FIG. 4 depicts a side cross-sectional view of a mid-region of the button 200 of FIG. 2 and indicates additional widths of the button at various points in this mid-region. As seen in FIG. 4, the diameter of the cross-section changes along the length of the mid-region of the button 200. For example, the cross-section of the button shaft 204 has a diameter, d₁, in the filleted rear shaft portion 234 of the button 200 proximate to the front surface 224 of the button back 202 in which d₀>d₁. Moving along the longitudinal axis of the button 200 toward the distal end of the button, the button shaft 204 has a diameter, d₂, in the filleted rear shaft portion 234 in which d₁>d₂. The button shaft 204 has a diameter, d₃, where the filleted rear shaft portion 234 meets the conical shaft portion 236 of the button shaft in which d₂>d₃. As noted above, the conical shaft portion 236 of the button shaft 204 tapers toward the cylindrical shaft portion 238. Accordingly, the button shaft 204 has a diameter, d₄, in the conical shaft portion 236 in which d₃>d₄. The button shaft 204 has a diameter, d₅, where the conical shaft portion 236 meets the cylindrical shaft portion 238 of the button shaft in which d₄>d₅. Continuing along the longitudinal axis of the button 200 toward the distal end of the button, the button shaft 204 has a diameter, d₆, in the cylindrical shaft portion 238 and a diameter, d₇, where the cylindrical shaft portion meets the filleted front shaft portion 244 in which d₅=d₆=d₇. It will be appreciated that, due to the practicalities of manufacturing the button, the diameters, d₅, d₆, and d₇ might not be exactly equal but rather may be considered to be the same when within practical manufacturing tolerances. The button shaft 204 has a diameter, d₈, where the filleted front shaft portion 244 meets the rear surface (246 in FIG. 3) of the button head (206 in FIGS. 2-3) in which d₈>d₇.

Alternative implementations of a button may exhibit different dimensions. For example, in a first alternative implementation, the button shaft may omit the cylindrical shaft portion and only include a conical shaft portion between the filleted rear shaft portion and the filleted front shaft portion. In this first alternative implementation, a diameter of a cross-section of the button shaft continuously reduces in a linear fashion when moving along the longitudinal axis of the button between the filleted rear shaft portion and the filleted front shaft portion. In a second alternative implementation, the button shaft may omit the conical shaft portion and only include a cylindrical shaft portion between the filleted rear shaft portion and the filleted front shaft portion. In this second alternative implementation, a diameter of a cross-section of the button shaft is uniform when moving along the longitudinal axis of the button between the filleted rear shaft portion and the filleted front shaft portion. In a third alternative implementation, the button shaft may include a cylindrical shaft portion positioned proximate to the proximal end of the button adjacent to the button back and a conical shaft portion positioned proximate to the distal end of the button adjacent to the button head. In a fourth alternative implementation, the button shaft may include a conical shaft portion in which a diameter of a cross-section of that conical shaft portion tapers when moving backward along the longitudinal axis of the button toward the proximal end of the button. In further implementations, the button shaft may omit one or both of the filleted rear shaft portion and the filleted front shaft portion such that a conical shaft portion and/or a cylindrical shaft portion form a non-filleted corner when meeting the front surface of the button back and/or the rear surface of the button head.

FIG. 4 also indicates various widths of the button core 208 at various points in the mid-region. As seen in FIG. 4, the cross-section of the button core 208 has different diameters at the circumferential grooves 254 and the cylindrical core body portion 256. For example, the button core 208 has a diameter, d₉, at the circumferential groove 254 of the button core and a diameter, dm, at the cylindrical body portion 256 in which d₁₀>d₉.

In alternative implementations, a button core may exhibit alternative dimensions. For example, in a first alternative implementation, a button core may omit the circumferential grooves. In a second alternative implementation, a button core may include one or more conical core body portions in which a cross-section of the conical core body portion tapers either toward or away from the distal end of the button.

FIG. 5 depicts a side cross-sectional view of a front region of the button 200 of FIG. 2 and indicates additional widths of the button at various points in this front region. As seen in FIG. 5, the diameter of the cross-section again changes along the length of the front-region of the button. For example, the button head 210 has a diameter, d₁₁, in the cylindrical head portion 240 in which d₁₁>d₈. The button head 210 has a diameter, d₁₂, in the conical head portion 242 in which d₁₁>d₁₂. The button head 210 has a diameter, d₁₃, where the conical head portion 242 meets the core head 210 in which d₁₂>d₁₃.

As noted above, the core head 210 in this example includes a linearly tapering region 260 positioned adjacent to the conical head portion 242 of the button head 210 as well as a non-linearly tapering region 262 positioned adjacent to the linearly tapering region and leading to the bladed edge 212. The cross-section of the core head 210 thus exhibits a linearly tapering edge 264 through the linearly tapering region 260 between the conical head portion 242 and the point where the linearly tapering region meets the non-linearly tapering region 262. The core head 210 thus has a diameter, d₁₄, in the linearly tapering region 260 in which d₁₁>d₁₄. The diameter of the linearly tapering region 260 tapers in a linear fashion between the conical head portion 242 and the point where the linearly tapering region meets the non-linearly tapering region 262. The core head 210 has a diameter, d₁₅, where the linearly tapering region 260 meets the non-linearly tapering region 262 in which d₁₄>d₁₅. The cross-section of the core head 210 in this example also exhibits a non-linearly tapering edge 266 through the non-linearly tapering region 262 between the linearly tapering region 260 and the point where the non-linearly tapering region meets the bladed edge 212. The core head 210 thus has a diameter, d₁₆, where the non-linearly tapering region 262 meets the bladed edge 212 in which d₁₅>d₁₆. The diameter of the non-linearly tapering region 262 tapers in a non-linear fashion between the linearly tapering region 260 and the point where the non-linearly tapering region meets the bladed edge 212. The non-linearly tapering edge 266 in this example is curved such that it may be described as having a flattened S-shape or a bell-like shape. The curve of the non-linearly tapering edge 266 imparts a contour to the core head 210 such that the non-linearly tapering edge may also be described as providing a ridge at the core head. The ridge of the contoured core head 210 may assist in the creation of an incision in the ear of the animal during application of the button-tag assembly.

In alternative implementations, a button head and a core head may exhibit alternative dimensions. For example, in one alternative implementation of a button head, that button head may omit the cylindrical head portion such that the diameter of the button head continuously tapers in a linear fashion between the filleted front shaft portion of the button shaft and the point at which the conical head portion meets the core head. In one alternative implementation of a core head, that core head may omit the non-linearly tapering region and instead only include a linearly tapering region such that the diameter of that core head continuously tapers in a linear fashion between the point at which the button head meets the core head and the point at which that linearly tapering region meets the bladed edge. In another alternative implementation of a core head, that core head may omit the linearly tapering region and instead only include a non-linearly tapering region such that the diameter of that core head continuously tapers in a non-linear fashion between the point at which the button head meets the core head and the point at which that non-linearly tapering region meets the bladed edge. The edge formed by the cross-section of the non-linearly tapering region may also exhibit alternative shapes. For example, alternative implementations of the non-linearly tapering region may provide a cross-section having a non-linearly tapering edge that exhibits a U-shape that either curves inward (e.g., a concave edge) or outward (e.g., a convex edge).

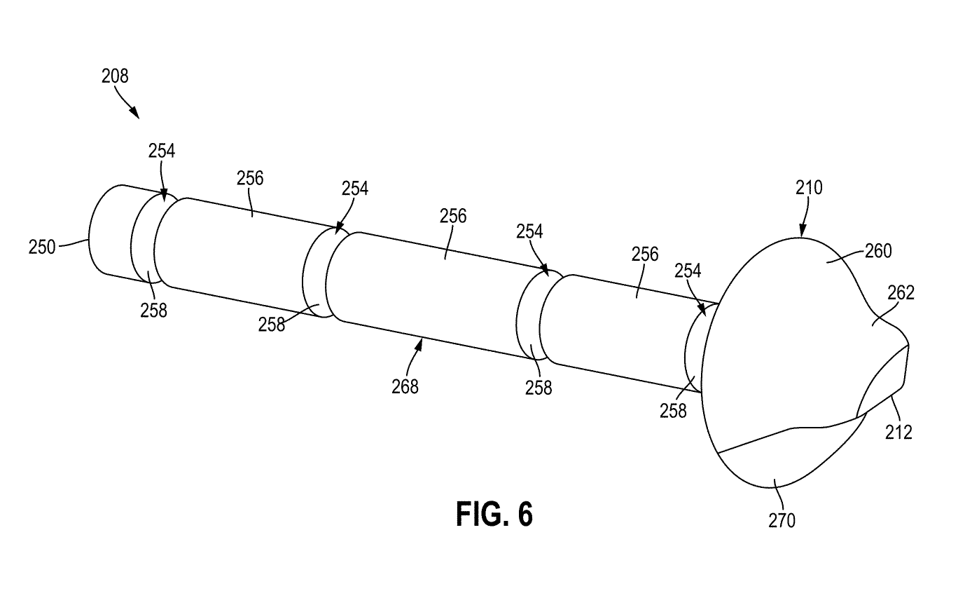

FIG. 6 depicts a top perspective view of the button core 208 of the button of FIG. 2. The button core 208 in this example includes a core end 250 positioned proximate to the proximal end of the button and a core head 210 positioned proximate to the distal end of the button. The button core 208 includes a core shaft 268 between the core end 250 and the core head 210. As noted above, a series of circumferential grooves 254 are formed in the core shaft 268 which divide the core shaft into a series of cylindrical core body portions 256. As also noted above, the circumferential grooves 254 in this example exhibit an arcuate contour 258 such that the face of the groove is curved around the circumference of the core shaft 268. In alternative implementations, a circumferential groove of the core shaft of a button core may exhibit a square-shaped contour such that the circumferential groove includes one or more flat faces around the circumference of the core shaft. The core head 210 in this example also includes a rim 270 that is positioned adjacent to and abuts the button head when the button core is embedded in the rest of the button. As further noted above, the core head 210 in this example includes a linearly tapering region 260 proximate to the core head rim 270 which leads to a non-linearly tapering region 262 which in turn leads to a bladed edge 212.

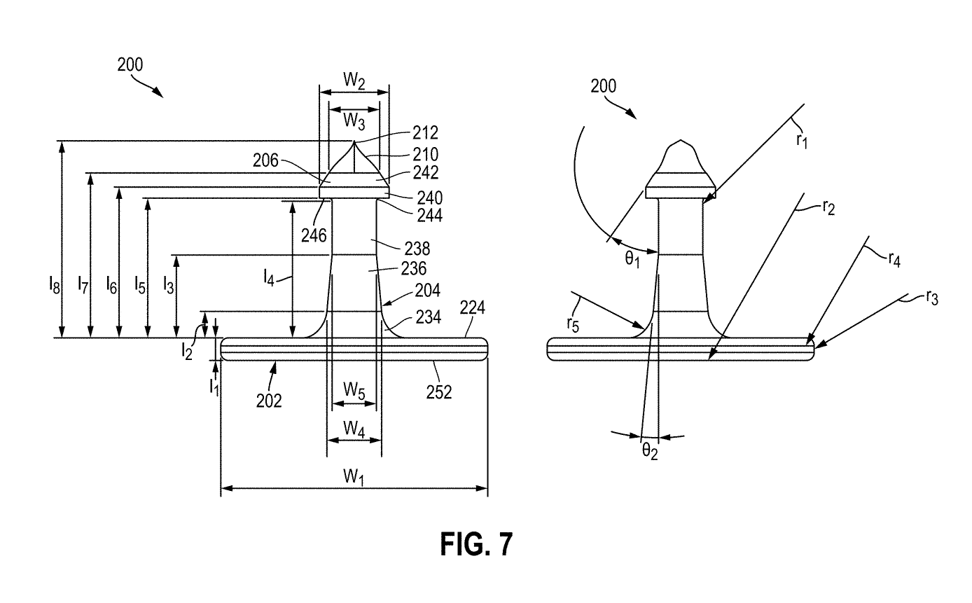

FIG. 7 depicts a pair of side views of the button 200 of FIG. 2 with example dimensions for various portions of the button. As noted above, the length of the button 200 is measured in this example along the longitudinal axis between the proximal end and the distal end of the button. The width of the button 200 is measured in this example along an axis that in perpendicular to the longitudinal axis of the button.

The button 200 in this example includes a length, l₄, measured from the rear surface 252 of the button back 202 from the front surface 224 of the button back. The length, l₄, may be between about 0.080 inches (in.) and about 0.10 in., and in some example implementations be about 0.090 in. The length, l₄, may also correspond to the thickness of the button back 202. The button 200 includes a length, l₂, measured from the front surface 224 of the button back to the point where the filleted rear shaft portion 234 meets the conical shaft portion 236. The length, l₂, may be between about 0.10 in. and about 0.20 in., and in some example implementations be about 0.114 in. The length, l₂, may thus correspond to the length of the filleted rear shaft portion 234 at its longest point, e.g., 0.114 in. The button 200 includes a length, l₃, measured from the front surface 224 of the button back 202 to the point where the conical shaft portion 236 meets the cylindrical shaft portion 238. The length, l₃, may be between about 0.40 in. and about 0.30 in., and in some example implementations be about 0.350 in. The length of the conical shaft portion 236 at its longest point may thus be about 0.236 in. in some example implementations. The button 200 includes a length, l₄, measured from the front surface 224 of the button back 202 to the point where the cylindrical shaft portion 238 meets the filleted front shaft portion 244. The length, l₄, may be between about 0.50 in. and about 0.60 in., and in some example implementations be about 0.565 in. The length of the cylindrical shaft portion 238 may thus be about 0.215 in. in some example implementations. The button 200 includes a length, l₅, measured from the front surface 224 of the button back 202 to the rear surface 246 of the button head 206. The length, l₅, may be between about 0.60 in. and about 0.50 in., and in some example implementations be about 0.590 in. The length, l₅, may thus correspond to the overall length of the button shaft 204 and include the length of the filleted rear shaft portion 234, the conical shaft portion 236, the cylindrical shaft portion 238, and the filleted front shaft portion 244. The button 200 includes a length, l₆, measured from the front surface 224 of the button back 202 to the point at which the cylindrical head portion 240 of the button head 206 meets the conical head portion 242 of the button head. The length, l₆, may be between about 0.60 in. and about 0.70 in., and in some example implementations be about 0.635 in. The length of the cylindrical head portion 240 of the button head may thus be about 0.045 in. in some example implementations. The button 200 includes a length, l₇, measured from the front surface 224 of the button back 202 to the point at which the conical head portion 242 of the button head 206 meets the core head 210 of the button core. The length, l₇, may be between about 0.60 in. and about 0.70 in., and in some example implementations be about 0.692 in. The length of the conical head portion 242 of the button head 206 at its longest point may thus be about 0.057 in. in some example implementations. Accordingly, the overall length of the button head at its longest point may be about 0.102 in. in some example implementations. The button includes a length, l₈, measured from the front surface 224 of the button back 202 to the tip of the bladed edge 212. The length, l₈, may be between about 0.80 in. and about 0.90 in., and in some example implementations be about 0.832 in. Accordingly, the overall length of the button 200 may be measured from the rear surface 252 of the button back 202 to the tip of the bladed edge 212. The length of the core head 210 at its longest point may thus be about 0.140 in. in some example implementations. The overall length of the button 200 may thus be between about 1.0 in. and about 0.90 in., and in some example implementations be about 0.922 in.

The button 200 in this example includes a width, w₁, measured across the button back 202. The width, w₁, may be between about 1.0 in. and about 1.2 in., and in some example implementations be about 1.120 in. As noted above, the overall width of the button 200 may be measured across the button back 202. The button 200 includes a width, w₂, measured across the cylindrical head portion 240 of the button head 206. The width, w₂, may be between about 0.2 in. and about 0.4 in., and in some example implementations be about 0.30 in. The button 200 includes a width, w₃, measured across the button head 206 at the point where the conical head portion 242 of the button head meets the core head 210 of the button core 208. The width, w₃, may be between about 0.2 in. and about 0.3 in., and in some example implementations be about 0.220 in. The button 200 includes a width, w₄, measured across the button shaft 204 at the point where the filleted rear shaft portion 234 of the button shaft meets the conical shaft portion 236 of the button shaft. The width, w₄, may be between about 0.2 in. and about 0.3 in., and in some example implementations be about 0.231 in. The button 200 includes a width, w₅, measured across the button shaft 204 at the point where the conical shaft portion 236 of the button shaft meets the cylindrical shaft portion 238 of the button shaft. The width, w₅, may be between about 0.1 in. and about 0.2 in., and in some example implementations be about 0.190 in. The widths, w₁₋₅, thus represent the diameters of the button 200 at its various regions.

The dimensions of various portions of a button may be calculated as a percentage of other portions of the button. For example, the overall length of a button may be between about 80% and about 90% of the overall width of the button, and in some example implementations be about 82% of the overall width of the button. The thickness of the button back of a button may be between about 5% and about 10% of the overall width of the button, and in some example implementations be about 8% of the overall width of the button. The length of the filleted rear shaft portion of a button may be between about 10% and about 20% of the overall length of the button, and in some example implementations may be about 12% of the overall length of the button. The length of the filleted rear shaft portion may alternatively be between about 10% and about 20% of the overall length of the button shaft of a button, and in some example implementations be about 19% of the overall length of the button shaft. The length of the conical shaft portion of a button may be between about 20% and about 30% of the overall length of the button, and in some example implementations may be about 26% of the overall length of the button. The length of the conical shaft portion may alternatively be between about 35% and about 45% of the overall length of the button shaft of a button, and in some example implementations be about 40% of the overall length of the button shaft. The length of the cylindrical shaft portion of a button may be between about 20% and about 30% of the overall length of the button, and in some example implementations may be about 23% of the overall length of the button. The length of the cylindrical shaft portion may alternatively be between about 30% and about 40% of the overall length of the button shaft of a button, and in some example implementations be about 36% of the overall length of the button shaft. The length of the filleted front shaft portion of a button may be between about 1% and about 5% of the overall length of the button, and in some example implementations may be about 3% of the overall length of the button. The length of the filleted front shaft portion may alternatively be between about 1% and about 5% of the overall length of the button shaft of a button, and in some example implementations be about 4% of the overall length of the button shaft. The width of the cylindrical shaft portion of the button shaft of a button may be between about 80% and about 90% of the width of the conical shaft portion of the button shaft at its widest point, and in some example implementations may be about 82% of the width of the conical shaft portion at its widest point. The width of the conical head portion of the button head of a button at its narrowest point may be between about 70% and about 80% of the width of the cylindrical head portion of the button head, and in some example implementations may be about 73% of the width of the cylindrical head portion.

As also seen in FIG. 7, the side views of the button 200 depict various radii of curvature for various portions of the button. For example, the button 200 includes a radius of curvature, r₁, at the filleted front shaft portion of the button shaft. The radius of curvature, r₁, may be between about 0.010 in. and about 0.020 in., and in some example implementations be about 0.016 in. The button includes a radius of curvature, r₂, at the 1st curved edge portion of the curved edge of the button back. The radius of curvature, r₂, may be between about 0.120 in. and about 0.130 in., and in some example implementations be about 0.125 in. The button includes a radius of curvature, r₃, at the 2^{nd} curved edge portion of the curved edge of the button back. The radius of curvature, r₃, may be between about 0.030 in. and about 0.040 in., and in some example implementations be about 0.031 in. The button includes a radius of curvature, r₄, at the 3^{rd} curved edge portion of the curved edge of the button back. The radius of curvature, r₄, may be between about 0.030 in. and about 0.040 in., and in some example implementations be about 0.031 in. The button includes a radius of curvature, r₅, at the filleted rear shaft portion. The radius of curvature, r₅, may be between about 0.20 in. and about 0.30 in., and in some example implementations be about 0.26 in. As further seen in FIG. 7, the button head and the button shaft form an angle, θ₁, between the conical head portion of the button head and the cylindrical shaft portion of the button shaft. The angle, θ₁, may be between about 30° and about 40°, and in some example implementations may be about 35°. The conical shaft portion of the button shaft also forms an angle, θ₂, between the narrowest point of the conical shaft portion and the widest point of the conical shaft portion. The angle, θ₂, may be between about 1° and about 10°, and in some example implementations be about 5°.

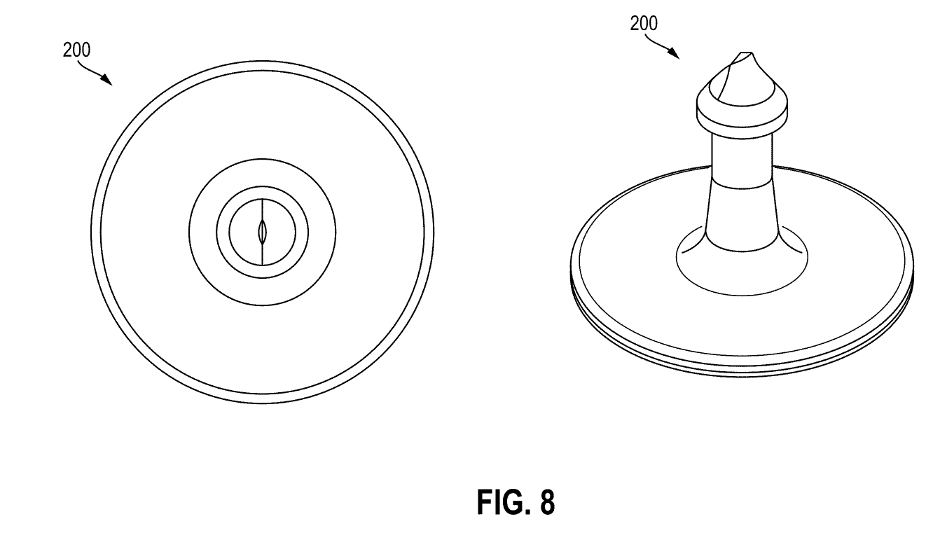

FIG. 8 depicts a top view and a top perspective view of the button 200 of FIG. 2.

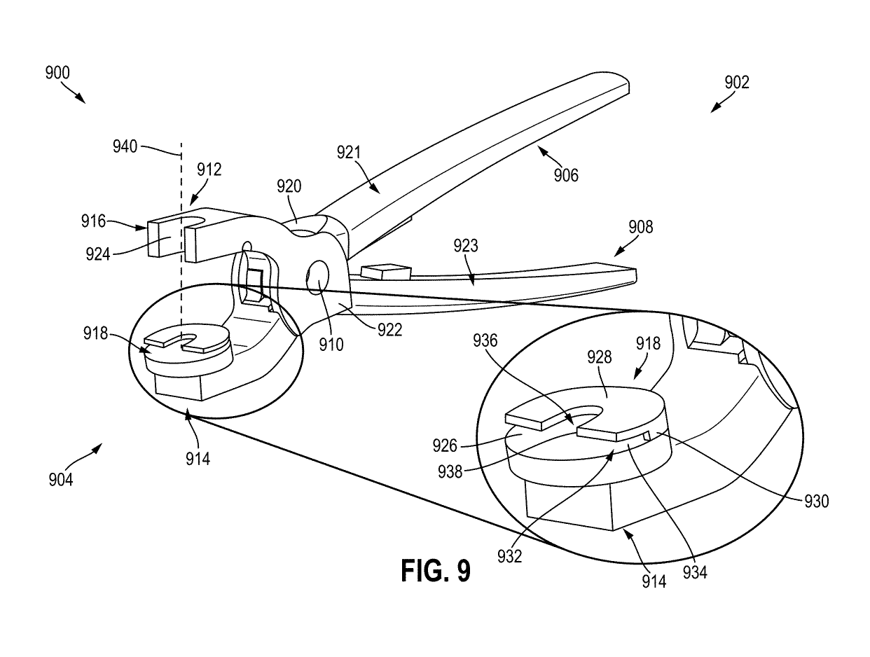

FIG. 9 depicts an example of an implementation of a button applicator 900 in accordance with aspects of the present disclosure. The button applicator 900 depicted in FIG. 9 may be described as a pin-less applicator as it does not use a pin to secure the button when applying the button-tag assembly to the ear of an animal. The button applicator 900 may be configured to provide at least about 16 lbf (pound-force). In example implementations, the maximum grip size of the button applicator 900 may be about 3.5 in. and the maximum overall length of the button applicator may be about 10 in.

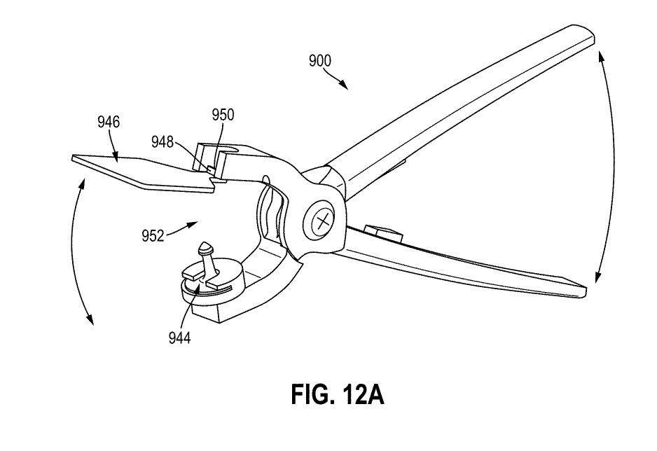

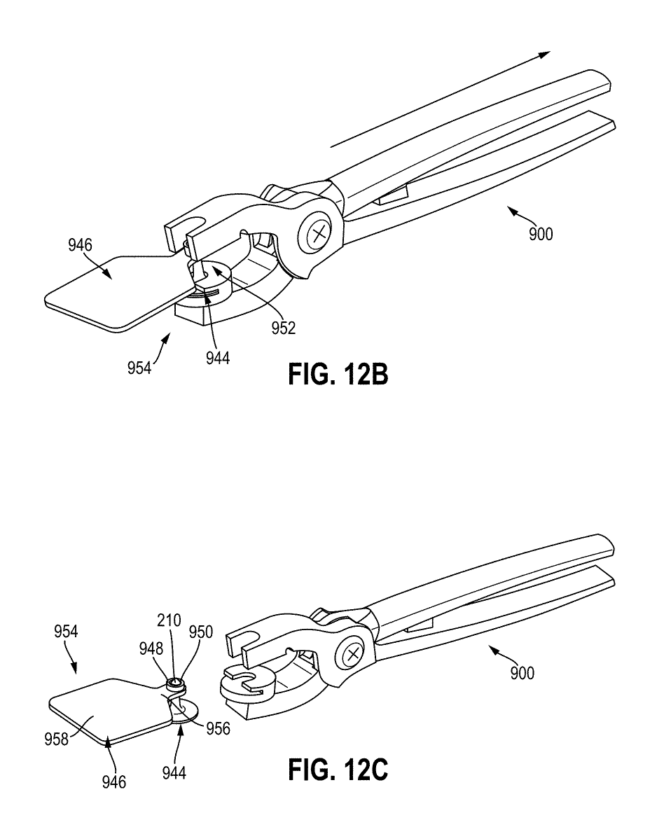

The button applicator 900, in this example, includes a grasping end 902 for holding the button applicator and an engagement end 904 for engaging a button and a tag. The grasping end 902 includes an upper handle 906 and a lower handle 908 that pivot around a hinge point 910 near the center of the button applicator 900. The engagement end 904 includes an upper jaw 912 and a lower jaw 914. The upper jaw 912 is configured to hold a tag and thus includes a tag holder 916. The lower jaw 914 is configured to hold a button and thus includes a button holder 918. The upper jaw 912 and lower jaw 914 likewise pivot around the hinge point 910. A right hinge portion 920 connects the upper handle 906 to the lower jaw 914, and a left hinge portion 922 connects the lower handle 908 to the upper jaw 912. The right hinge portion 920 and the left hinge portion 922 mesh at the hinge point 910. Accordingly, moving the upper handle 906 in a downward direction moves the lower jaw 914 in a corresponding upward direction, and moving the lower handle 908 in an upward direction moves the upper jaw 912 in a corresponding downward direction. In other words, moving the upper handle 906 and lower handle 908 toward each other moves the upper jaw 912 and lower jaw 914 toward each other. As described in further detail below with reference to FIGS. 12A-C, the movement of the upper jaw 912 and lower jaw 914 in this fashion engages a button with a tag. The upper handle 906, right hinge portion 920, and lower jaw 914 thus form a button holder arm 921 of the button applicator 900. The lower handle 908, left hinge portion 922, and upper jaw 912 thus form a tag holder arm 923 of the button applicator 900.

The tag holder 916 of the upper jaw 912 is configured to hold a tag in place during application of the button-tag assembly to the ear of an animal. The tag holder 916 in this example includes a tag receptacle 924 configured to hold, for example, a head, neck, collar, or stem of a tag. The tag receptacle 924, in this example, has a U-shaped configuration for receiving a correspondingly shaped head, neck, collar or stem of a tag. Receipt of the tag in the tag receptacle 924 is illustrated in FIGS. 12A-C and described in further detail below.

The button holder 918 of the lower jaw 914 is configured to hold a button in place during application of the button-tag assembly to the ear of an animal. FIG. 9 includes a close-up view of the button holder 918 and its components. The button holder 918, in this example, includes a substantially flat flange platform 926 the flange of the button rests upon and a flange cover 928 that covers at least a portion of the button flange. The flange cover 928 is spaced apart from the flange platform 926, and the flange cover is connected to the flange platform by a rear wall 930. The flange platform 926, flange cover 928, and wall 930 thus form a flange receptacle 932 for the button flange. The distance between the flange cover 928 and the flange platform 926 may be slightly larger than the thickness of the button flange so as to hold the button flange in the flange receptacle 932. The front edge of the flange cover 928 extends past front edge of the wall 930 such that a notch 934 is formed between the flange cover 928 and flange platform 926 at the front end of the flange receptacle 932 for the button flange. The flange cover 928, in this example, has a semi-circular shape and also includes a shaft receptacle 936 for the button shaft. The shaft receptacle 936 for the button shaft, in this example, is a U-shaped notch formed in the flange cover 928 from the front edge of the flange cover to the center of the flange cover. When a user inserts a button into the button holder 918, the flange receptacle 932 receives the button flange, and the shaft receptacle 936 receives the button shaft. As seen in FIG. 9, the placement point 938 of the button in the button holder 918 aligns with a central axis 940 of the tag receptacle 924. The button shaft is thus aligned with a center of an aperture of a tag held in the tag receptacle 924.

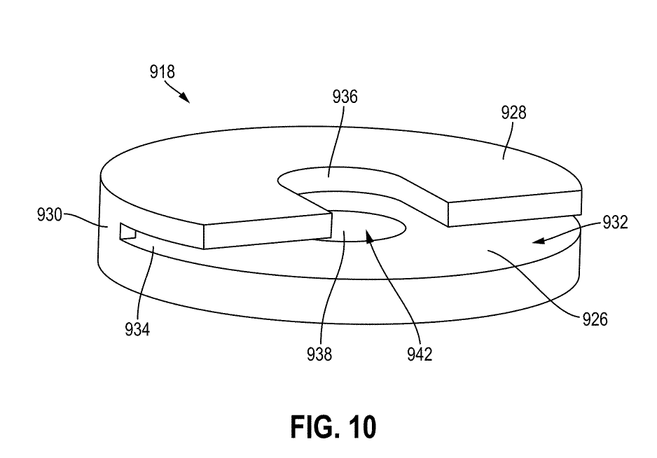

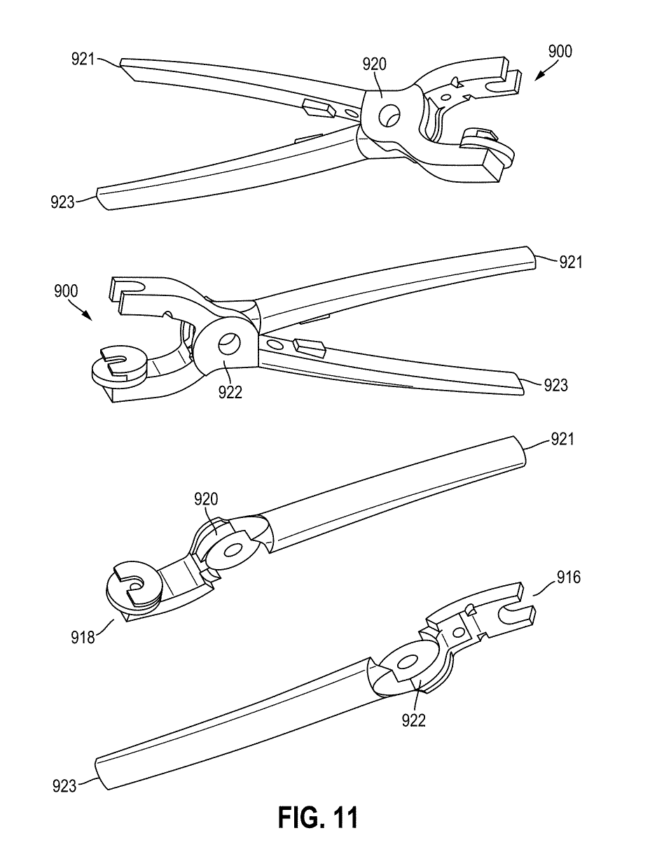

FIG. 10 depicts a top perspective view of the button holder 918 of the button applicator of FIG. 9. In some example implementations of the button holder 918, the flange platform 926 that supports the button flange includes a magnet 942 embedded in the flange platform at the placement point 938. Accordingly, when a button having a metallic core is utilized, the magnet 942 further secures the button in the button holder 918. In example implementations, the diameter of the magnet 942 is substantially the same as the diameter of the metallic core of the button.

FIG. 11 depicts various perspective views of the button applicator 900 of FIG. 9 and its components. For example, a bottom-right perspective view and a top-left perspective view of the button applicator 900 are depicted with the button holder arm 921 meshed with the tag holder arm 923 at the pivot point. In addition, a top-left perspective view of the button holder arm 921 and a bottom-right perspective view of the tag holder arm 923 are depicted individually. In example implementations, the button holder arm 921 and the tag holder arm 923 are casted from aluminum. A press-fit pin may be used to secure the button holder arm 921 to the tag holder arm 923 at the hinge point.

FIG. 12A depicts the button applicator 900 of FIG. 9 configured with an example button 944 and an example identification tag 946 in example use. As seen in FIG. 12A, the tag 946 has been received in the tag holder of the button applicator 900, and the button 944 has been received in the button holder of the button applicator. The tag 946, in this example, includes a collar 948 having an aperture 950 through which the button shaft is received. The tag receptacle secures the collar 948 of the tag 946 to hold the tag in place during the application process. The button holder 918 likewise secures the button 944 to hold the button in place during the application process. In FIG. 12A, the button applicator 900 is depicted in an “open” position. In the “open” position, the upper jaw and lower jaw are positioned apart from one another forming an ear-receiving region 952 between the tag and the button.

The arrows respectively shown at the grasping end and the engaging end of the button applicator 900 indicate the direction of movement of the upper and lower handles as well as the upper and lower jaws. The ear of an animal may be received with the ear-received region 952 and positioned between the button 944 and the tag 946. A user may then operate the button applicator to engage the button 944 with the tag 946 and form the button-tag assembly. As noted above, by moving the upper and lower handles of the button applicator 900 toward each other, the upper and lower jaws move toward each other. As the upper and lower jaws move toward each other, the shaft of the button 944 passes through the ear of the animal and engages with the tag 946. For example, the shaft of the button 944 passes through the aperture 950 of the collar 948 of the tag 946. As the button 944 moves toward the tag 946, the head of the button either punctures (e.g., when the core head includes a pointed tip) or makes an incision at (e.g., when the core head includes a bladed edge) the ear of the animal allowing the rest of the button shaft to pass through the ear. The aperture 950 of the collar 948 of the tag 946 may have a diameter that allows one-way movement of the head of the button 944 through the aperture. In other words, the aperture 950 of the collar 948 of the tag 946 may permit the core head of the button 944 to pass through in one direction but prevent the core head from being pulled back through the aperture in the opposite direction.

FIG. 12B depicts example operation of the button applicator 900 of FIG. 9. As seen in FIG. 9, the button applicator is depicted in a “closed” position. Having moved from the “open” position (shown in FIG. 12A) to the “closed” position, the button 944 has engaged the tag 946 as described above to form the button-tag assembly 954. The user may then release the button-tag assembly 954 from the button applicator 900. As seen in FIG. 12B, the respective receptacles formed at the tag holder and the button holder of the button application 900 permit the user to easily release the button-tag assembly 954 from the button applicator by pulling the applicator back and away from the ear of the animal. Having been secured to the ear of the animal, the button-tag assembly 954 remains in place as the button flange is released from the receptacle of the button holder and the collar 948 of the tag 946 is released from the tag receptacle when the user pulls the button applicator 900 away from the ear of the animal. In this way, the user may apply and release the button-tag assembly 954 in one smooth motion with one hand. In addition, pin-based applicators can jam or tug on the ear of the animal if the user attempts to pull the applicator away without releasing the handles. The pin-less design of the button applicator 900, however, avoids tugging on the ear of the animal when the user pulls the button applicator away without releasing the handles since the button-tag assembly 954 is released when the user pulls the button applicator away. By avoiding tugging on the ear of the animal the risk of tearing the ear is reduced. The operation of the button applicator 900 described herein thus provides an efficient means for applying button tag-assemblies in quick succession. The hinge point of the button applicator 900 may be spring-loaded so as to automatically return the button applicator from the “closed” position to the “open” position when the user releases the grip on the upper and lower handles. For example, a spring may be compressed and secured into retention holes formed in the button holder arm and the tag holder arm behind the hinge point of a button applicator which ensures the resting position of the button applicator is the “open” position. The upper and lower handle may also include a rubber coating which may be applied by dipping the handles in a rubberized vat.

FIG. 12C depicts an example of an implementation of a button-tag assembly 954 formed with the button applicator 900 of FIG. 9. The core head 210 of the button 944 has been secured in the collar 948 of the tag 946. The tag 946, in this example, includes a neck 956 connected to and extending from the collar 948 as well as a body 958 connected to and extending from the neck. The body 958 of the tag 946 may include, for example, identification information including a unique identifier for the animal (e.g., an ID number), the name of the owner of the animal, as well as any other information associated with the animal. The information may be applied to the tag in a human-readable format (e.g., alphanumeric characters) or encoded in an optical machine-readable format (e.g., a linear barcode, a matrix barcode, and the like). The tag 946 may also include a radio frequency identification (RFID) chip that encodes any of the information above. The RFID chip may, in some example implementations, be a passive RFID chip that transmits the information in response to receipt of interrogating radio waves from an RFID reader. In other implementations, the RFID chip may include a local power source and transmitter that transmits the information at a regular interval, at an irregular interval, or on-demand in response to an interrogation from an RFID reader. The information applied to the tag 946 or encoded by the RFID chip may be encrypted using various encryption techniques.

As seen in FIG. 12C, the button applicator 900 has been pulled back to release the button-tag assembly 954 from the tag holder and button holder. Although the ear of the animal has been omitted from FIGS. 12A-C, in actual practice the ear of the animal would be positioned between the flange of the button 944 and the collar 948 of the tag 946. As seen in FIGS. 12A-C, the button-tag assembly 954 may be applied to the ear of an animal without a portion of the button applicator 900 entering or passing through the ear of the animal. In addition, the solid core of the button 944 helps to prevent buckling of the button material when applying the button-tag assembly 954. In some example implementations, a button applicator may include a multi-tool in which various tools are attached to or otherwise stored in or at the button applicator. For example, in some example implementations, a button applicator may include one or more of a knife, a reamer, a bottle-opener, a screwdriver, wire stripper, file, rasp, tweezers, scissors, magnifying glass, wrench, pliers, knife, hammer, corkscrew, saw, light source (e.g., light emitting diode—LED light), chisel, writing implement, and the like. Providing one or more of these tools in or at a button applicator may be useful when applying button-tag assemblies in the field.

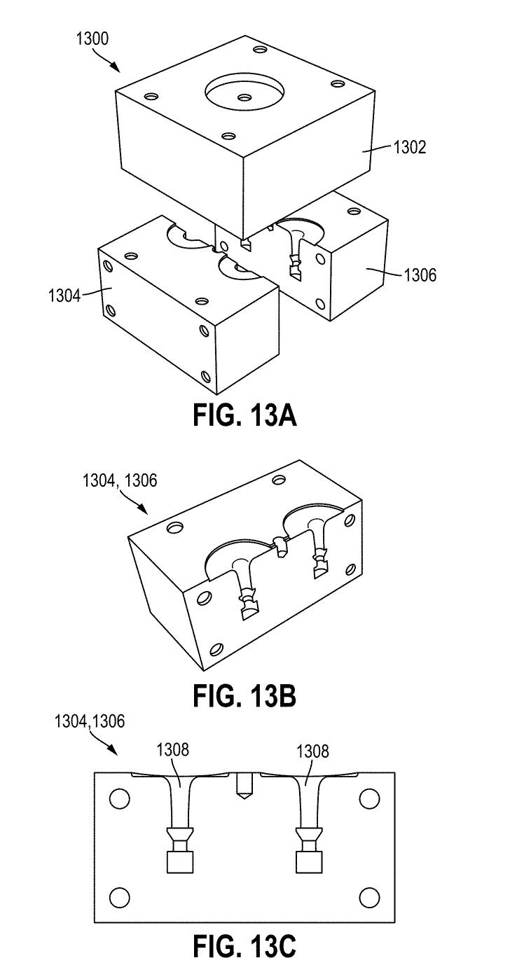

FIG. 13A depicts a top perspective view of an example of an implementation of a button mold assembly 1300 in an exploded configuration and in accordance with aspects described herein. The button mold assembly 1300, in this example, includes mold assembly top portion 1302, a mold assembly front portion 1304, and a mold assembly rear portion 1306. As seen in FIG. 13A, the mold assembly front portion 1304 and the mold assembly rear portion 1306 are mirror images of each other and form a mold cavity within the button mold assembly.

FIG. 13B depicts a top perspective view of a mold assembly portion (e.g., the mold assembly front portion 1304 or the mold assembly rear portion 1306) of the button mold assembly 1300 of FIG. 13A.

FIG. 13C depicts a side view of a mold assembly portion (e.g., the mold assembly front portion 1304 or the mold assembly rear portion 1306) of the button mold assembly 1300 of FIG. 13A. The mold assembly portion, in this example, forms two adjacent mold cavities 1308 for forming two buttons at a time in a single button mold assembly.

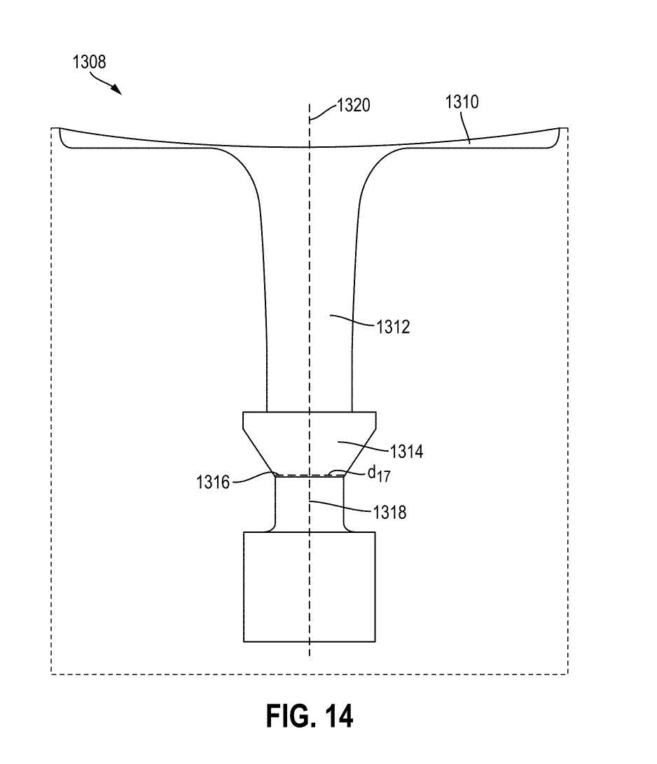

FIG. 14 depicts a side view of a mold cavity 1308 of a mold assembly portion (e.g., mold assembly front portion 1304 or mold assembly rear portion 1306) of the button mold assembly 1300 of FIG. 13A. The mold cavity 1308, in this example, includes various cavity portions for forming the various portions of a button. For example, the mold cavity 1308 includes a flange-forming cavity portion 1310 for forming a flange of a button, a shaft-forming cavity portion 1312 for forming a shaft of the button, and a head-forming cavity portion 1314 for forming a head of the button. To form the button, a core (e.g., the metallic core of FIG. 3) may be inserted into the mold cavity 1308. The head-forming cavity portion 1314 may have a diameter, d₁₇, that is about the same as the largest diameter of the core head of the button (e.g., diameter, d₁₃, in FIG. 5). Accordingly, the rim of the core head of a button core may rest on the interior rim 1316 of the head-forming cavity portion 1314. In addition, the mold cavity 1308, in this example, includes a head-receiving cavity portion 1318 that receives the core head of the button core when it is inserted into the mold cavity. In this way, the mold cavity 1308 may be filled such that the shaft of the button core is embedded into, e.g., the button shaft and the button back while leaving the head of the core exposed. When inserted into the mold cavity 1308, the button core may be aligned with a central axis 1320 of the mold cavity. Various mold injection techniques may be utilized to form a button using the button mold assembly.

It will also be appreciated that the entirety of the button may be formed from a thermoplastic elastomer, metallic material, or other durable material (e.g., high strength polymers such as fiber-reinforced polymers and polyether ether ketone—PEEK). Accordingly, in embodiments where the entirety of the button is formed from a metallic material, various forging or casting techniques may be employed to form the button. Forging and casting techniques may also be selectively employed to form portions of the button in embodiments formed from different types of materials (e.g., a thermoplastic elastomer and a metallic material).

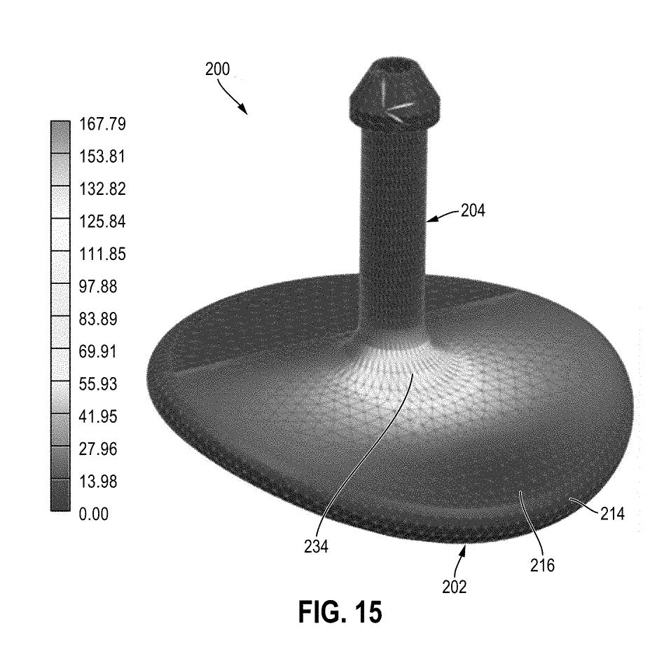

FIG. 15 depicts a first stress analysis diagram for the button 200 of FIG. 2 without the button core. As seen in FIG. 15, the button 200 has been deformed by applying a downward force on the flange 216 of the button back 202 near the curved edge 214. As a result of this downward force, the button 200 experiences a relatively large amount of stress at the filleted rear shaft portion 234 of the button shaft 204, e.g., between about 90 MPa to about 115 MPa.

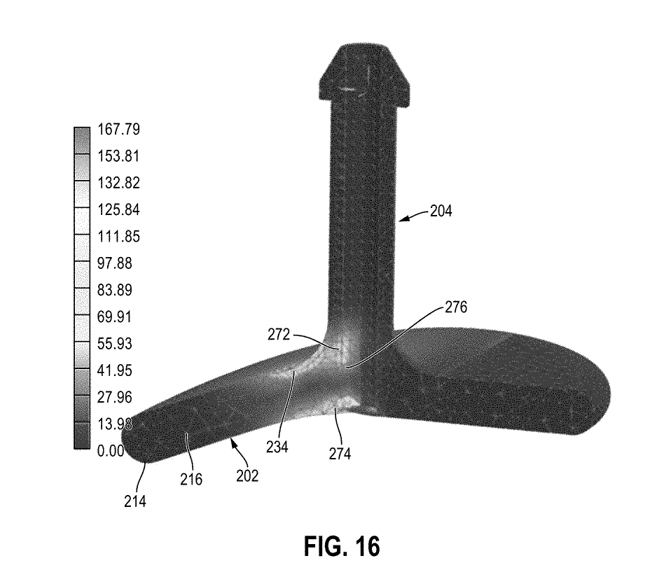

FIG. 16 depicts a second stress analysis diagram for the button 200 of FIG. 2 without the button core. A cross-sectional view of the button 200 is illustrated in FIG. 16 in order to depict stress at the interior wall 272 of the button shaft 204 and at the perimeter 274 of the button void 276 at the button back 202. The button 200 has been similarly deformed in FIG. 16 by applying a downward force on the flange 216 of the button back 202 near the curved edge 214. As a result of this downward force, the button 200 also experiences a relatively large amount of stress at the interior wall 272 of the button void 276 and the perimeter 274 of the button void, e.g., between about 55 MPa and about 90 MPa.

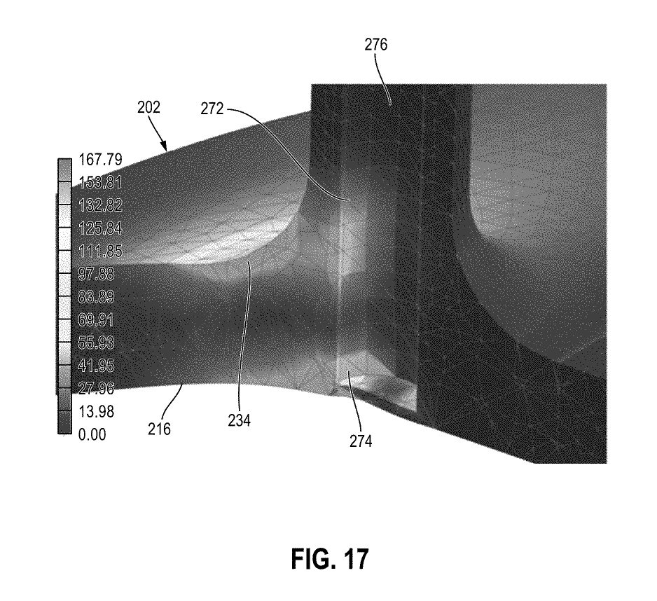

FIG. 17 depicts a third stress analysis diagram for the button 200 of FIG. 2 without the button core. In FIG. 17, a close-up view of the filleted rear shaft portion 234, the interior wall 272 of the button void 276, and the perimeter 274 of the button void is shown to further illustrate the stress experienced at these regions in response to deforming the flange 216 of the button back 202 as described above.

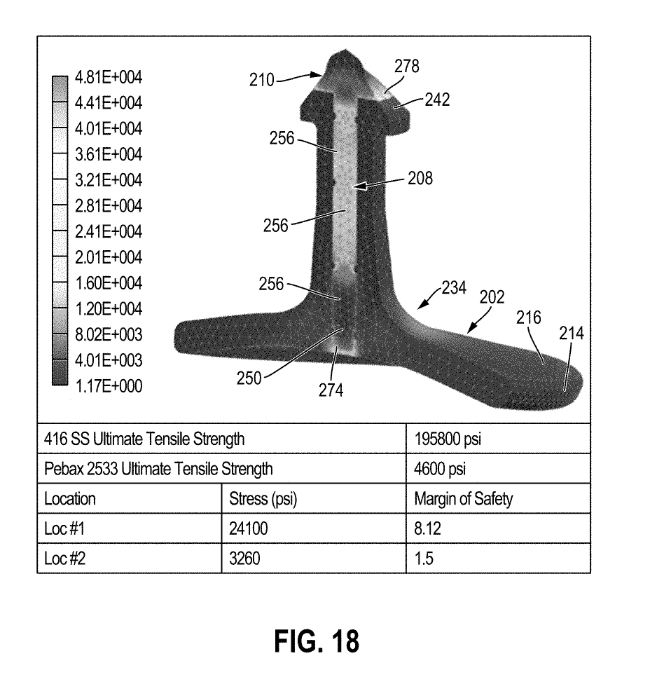

FIG. 18 depicts a stress analysis diagram for the button 200 of FIG. 2 with the button core 208. The button 200 in FIG. 18 has again been deformed by applying a downward force on the flange 216 of the button back 202 near the curved edge 214. As seen in FIG. 18, the button 200 absorbs much of the resulting stress, e.g., at the core end 250 of the button core 208, around the perimeter 278 of the core head 210, and throughout the cylindrical core body portions 256.

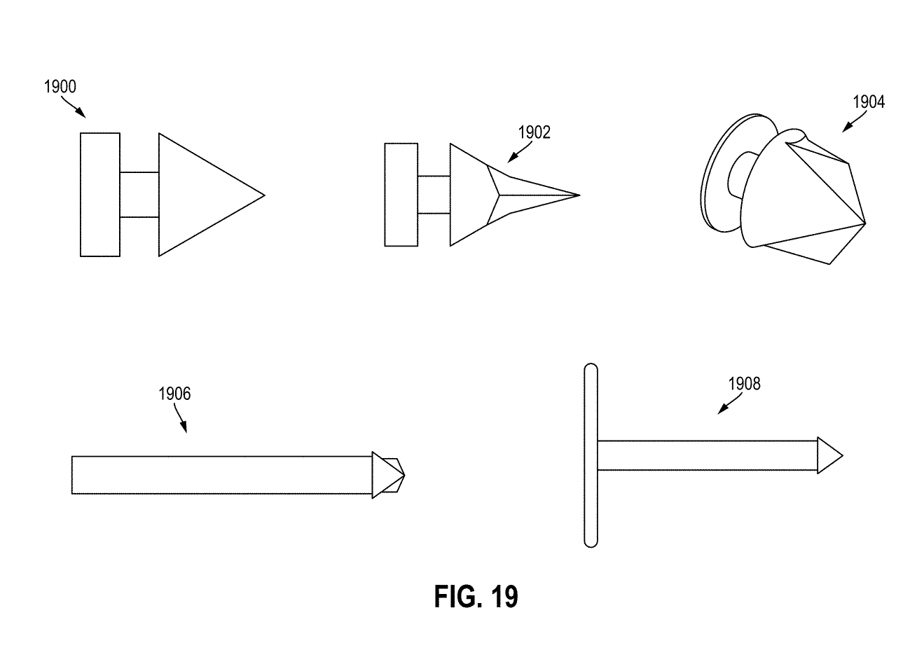

FIG. 19 depicts a set of alternative embodiments 1900-1908 for a button head of a button for an animal identification tag in accordance with aspects described herein. For example, the alternative button head 1900 has a core head having a substantially conical shape and a pointed tip. The alternative button head 1902 has a core head having a first tapering region, a second tapering region, and a pointed tip in which both the first and second tapering regions taper in a linear fashion and in which the first tapering region tapers at a greater degree than the second tapering region. The alternative button head 1904 similarly has a core head having a substantially conical shape and also includes two triangular bladed wings extending away from the conical portion and positioned opposite each other. The alternative button head 1906 includes a core head similar to that of the alternative button head 1904 and includes a core shaft having a diameter that is almost as large as the overall diameter of the core head. The alternative button head 1908 includes a core head similar to that of the alternative button head 1900 and likewise includes a core shaft having a diameter that almost as large as the overall width of the core head.

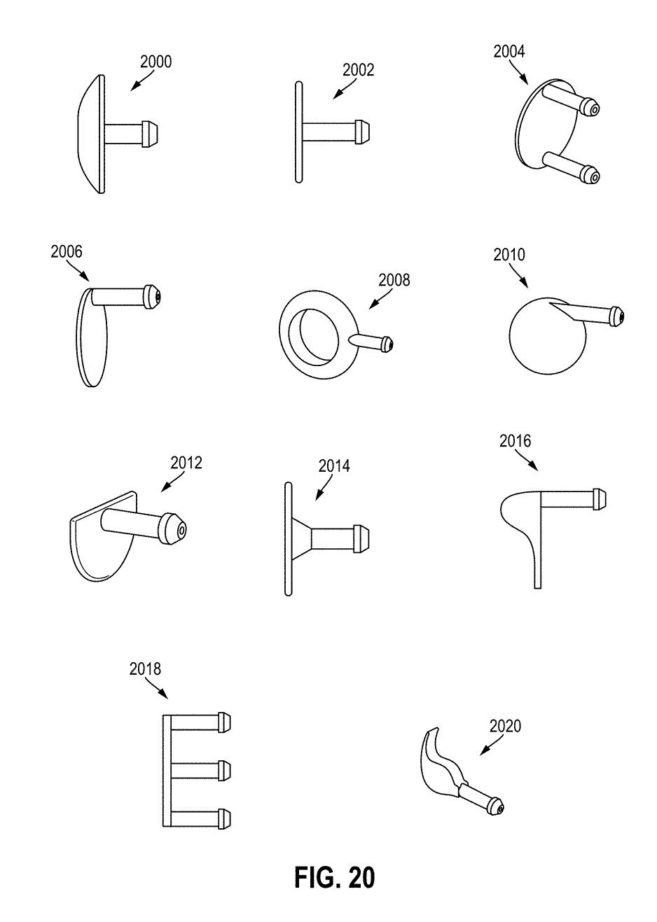

FIG. 20 depicts alternative embodiments of button backs 2000-2020 of a button for an animal identification tag in accordance with aspects described herein. The alternative embodiments for the button backs depicted in FIG. 20 include alternative shapes, alternative dimensions, and alternative positions for the button shaft relative to the button back, e.g., positioned near the edge of the button back (e.g., alternative button backs 2004, 2006, 2010, 2012, and 2016) rather than at the center of the button back. In addition, some of the alternative button backs are configured to accommodate multiple button shafts (e.g., alternative button backs 2004 and 2018).

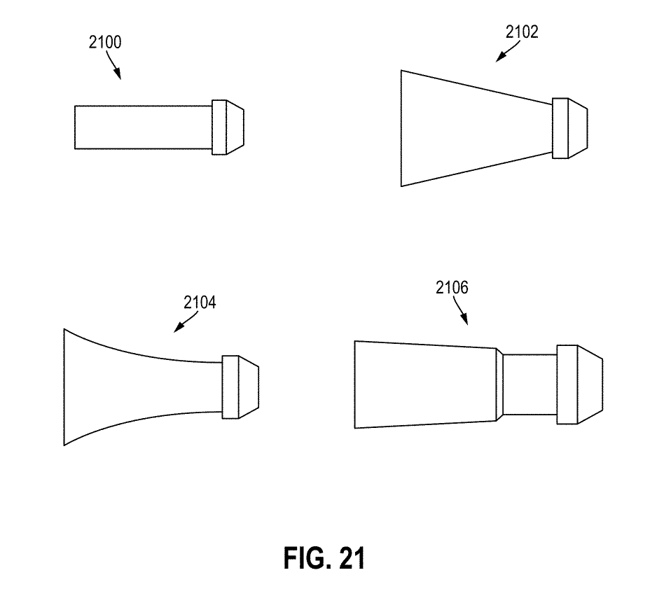

FIG. 21 depicts alternative embodiments of button shafts 2100-2106 of a button for an animal identification tag in accordance with aspects described herein. For example, in the alternative button shaft 2100, only a cylindrical shaft portion is connected to the button head. In the alternative button shaft 2102, only a conical shaft portion is connected to the button head in which the diameter of the conical shaft portion tapers in a linear fashion toward the button head. In the alternative shaft 2104, only a shaft portion is connected to the button head in which the diameter of the shaft portion tapers in a non-linear fashion toward the button head, e.g., curves inwardly along the length of the button shaft toward the button head. The alternative shaft design 2106 includes a conical shaft portion, a cylindrical shaft portion, and a ridge formed between the conical shaft portion and the cylindrical shaft portion.

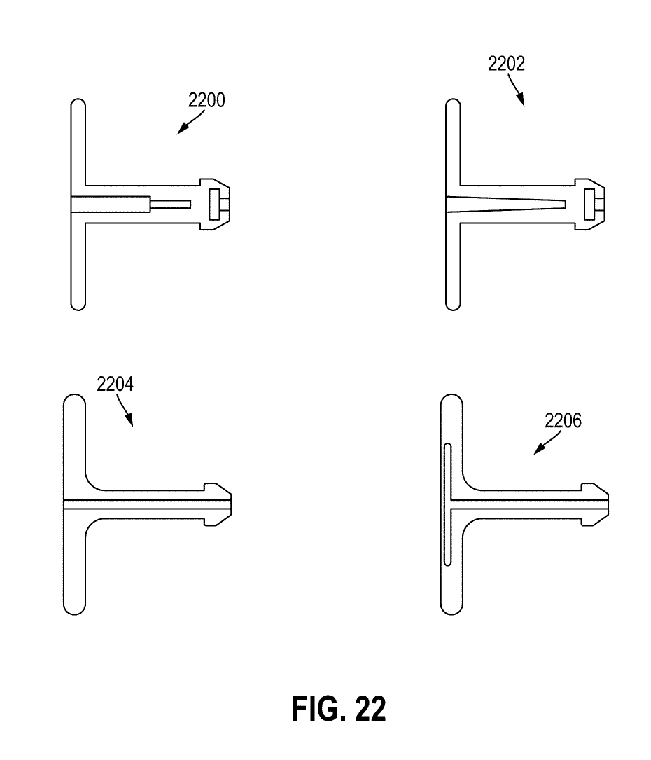

FIG. 22 depicts alternative embodiments of button core voids 2200-2206 of a button for an animal identification tag in accordance with aspects described herein. For example, the alternative button core void 2200 has a first diameter at a first core void region and a second diameter at a second core void region, the second diameter being smaller than the first diameter, in other words, a stepped button core void. The first core void region extends through the button back and into the button shaft where it connects to the second core void region which extends through the button shaft toward the button head. The alternative button core void 2202 includes a core void that extends through the button back and the button shaft and that tapers toward the button head. The alternative button core void 2202 tapers in a linear fashion toward the button head. As seen in FIG. 22, the alternative button core voids 2200 and 2202 do not extend into or through the button head. Accordingly, the alternative button core voids 2200 and 2202 each include a void in the button head into which a core head may be embedded. The alternative button core void 2204 includes a substantially straight core void that extends through the button back, button shaft, and button head. The alternative button core void 2206 includes a first substantially straight core void portion that extends through the button back, button shaft, and button head as well as a second substantially straight core void portion extending across the button back and positioned substantially perpendicular to the first substantially straight core void portion. Buttons implementing the alternative button core voids 2200-2206 depicted in FIG. 22 may include cores having corresponding shapes for residing in those button core voids.

Various implementations of the button may incorporate any combination of the embodiments of the button heads 1900-1908, button backs 2000-2020, button shafts 2100-2106 and/or button core voids 2200-2206 described herein and depicted in the accompanying figures.

Aspects of this disclosure have been described in terms of example embodiments thereof. Numerous other embodiments, modifications and variations within the scope and spirit of disclosed principles will be appreciated upon review of this entire disclosure.

For example, in some example embodiments, the core may only be embedded in the button head. In these example embodiments, the button back and the button shaft may lack an interior void but rather have a solid interior construction. In other example embodiments, the core may only extend part of the way into the button shaft, for example, x % of the length of the button shaft where x is 1-99% (e.g., 10%, 25%, 50%, 75%, etc.) or one-half, one-third, one-fourth, one-fifth, etc. of the way into the button shaft. Reducing the extent to which the core extends into the button shaft may reduce the amount of material needed to construct the core thereby reducing the overall cost to construct the button.

As another example, the flange of the button may include features that reduce the amount of material required to construct the button. Referring back to FIG. 2, the button shown by way of example includes a button back having a flange with a solid construction. In other example implementations, however, the flange may include one or more apertures to reduce the amount of material needed to construct the button. Alternatively, some example embodiments may include radial spokes that extend from a center region of the shaft to the edge of the button back thus also reducing the amount of material needed to construct the button. Reducing the amount of material needed to construct the button may likewise reduce the overall cost to construct the button.

Alternative dimensions for the button include the following: an outer diameter of about 0.5 in. to about 1.5 in.; a button shaft length of about 0.5 in. to about 0.75 in.; a button shaft diameter of about 0.20 in. to about 0.30 in.; a button back thickness of about 0.06 in. to about 0.15 in.; a minimum button back thickness of greater than about 0.06 in.; an overall button length of about 2.0 in.; and a tip radius of less than about 0.007 in.

Additional examples of various embodiments and implementations will be appreciated upon review of the entirety of the disclosures provided herein.

What is claimed is:

1. A button for an animal identification tag, the button comprising:
a button body, the button body comprising:
a button back having a circular cross-sectional shape, the button back having a front surface and a rear surface and the rear surface of the button back forming a proximal end of the button;
a button shaft extending from a center portion of the front surface of the button back, the button shaft having a filleted rear shaft portion extending from the button back, a conical shaft portion extending from the filleted rear shaft portion, a cylindrical shaft portion extending from the conical shaft portion, and a filleted front shaft portion extending from the conical shaft portion; and
a button head extending from the filleted front shaft portion of the button shaft, the button head including a cylindrical head portion engaged with the filleted front shaft portion of the button shaft and a conical head portion extending from the cylindrical head portion;
a core embedded within the button body and extending from the button head, the core comprising:
a core shaft having a proximal end and a distal end, the core shaft extending through a longitudinal axis of the button and extending through at least a portion of the button head and the button shaft, the core shaft including a plurality of circumferential grooves; and
a core head extending from the distal end of the core shaft, the core head having a linearly tapering region engaged and substantially flush with the conical head portion of the button head, a non-linearly tapering portion extending from the linearly tapering portion, and a bladed edge extending from non-linearly tapering portion, the bladed edge forming a ridge along a distal end of the button;
wherein the button body is comprised of a first material and the core is comprised of a second material;
wherein the first material is a thermoplastic elastomer material and the second material is a metallic material; and
wherein the button is substantially free of any voids.

2. The button of claim 1, wherein the core extends entirely through each of the button back, the button shaft, and the button head.

3. The button of claim 1, wherein the proximal end of the core is flush with the rear surface of the button back.

4. The button of claim 1, wherein the front surface of the button back is substantially flat.

5. The button of claim 1, wherein the front surface of the button back is convex.

6. The button of claim 1, wherein the front surface of the button back is concave.

7. The button of claim 1, wherein the core is comprised of a magnetic material.

8. The button of claim 1, wherein an outer surface of the core comprises a feature to promote bonding between the core and the button body.

9. The button of claim 1, wherein an overall length of the button is between about 80% and about 90% of an overall width of the button.

10. The button of claim 1, wherein a thickness of the button back is between about 5% and about 10% of an overall width of the button.

11. The button of claim 1, wherein a length of the filleted rear shaft portion is between about 5% and about 10% of an overall length of the button.

12. The button of claim 1, wherein a length of the conical shaft portion is between about 20% and about 30% of an overall length of the button.

13. The button of claim 1, wherein a length of the cylindrical shaft portion is between about 20% and about 30% of an overall length of the button.

14. A button for an animal identification tag, the button comprising:
a button body, the button body comprising:
a button back, the button back having a front surface and a rear surface and the rear surface of the button back forming a proximal end of the button;
a button shaft extending from the front surface of the button back, the button shaft having a proximal end engaged with the button back and having a distal end; and
a button head extending from the distal end of the button shaft, the button head having a proximal end engaged with the distal end of the button shaft and having a distal end; and
a core embedded within the button body and extending from the distal end of the button head, the core comprising:
a core shaft having a proximal end and a distal end, the core shaft extending through at least a portion of the button head and the button shaft; and
a core head extending from the distal end of the core shaft and extending from the distal end of the button head, the core head forming a core tip at the distal end of the button;
wherein the button is substantially free of any voids.

15. The button of claim 14, wherein the button body is comprised of a first material and the core is comprised of a second material.

16. The button of claim 15, wherein the first material is different than the second material.

17. The button of claim 16, wherein the first material is a thermoplastic elastomer material and the second material is a metallic material.

18. The button of claim 14, wherein the core tip comprises a bladed edge.

19. The button of claim 18, wherein the bladed edge forms a ridge along the distal end of the button.

20. The button of claim 14, wherein the core has a bell-like shape.

21. The button of claim 14, wherein the button back has circular cross-sectional shape.

22. The button of claim 21, wherein the button shaft extends from a center portion of the button back.

23. The button of claim 14, wherein the core extends through a longitudinal axis of the button.

24. The button of claim 14, wherein the core shaft includes at least one circumferential groove.

25. The button of claim 14, wherein an outer surface of the core head is flush with an outer surface of the button head.

26. The button of claim 14, wherein the core extends entirely through each of the button back, the button shaft, and the button head.

27. The button of claim 26, wherein the proximal end of the core shaft is flush with the rear surface of the button back.

28. The button of claim 14, wherein the front surface of the button back is substantially flat.

29. The button of claim 14, wherein the button shaft tapers in a direction moving from the proximal end of the button shaft toward the distal end of the button shaft.

30. A button applicator pivotable between an open position and a closed position and configured to apply a button-tag assembly to an animal, the button applicator comprising:
a button holder arm comprising:
a first handle; and
a first jaw, the first jaw having a flange platform, a rear wall extending upward from the flange platform, and a flange cover extending outward from the rear wall forming a button flange receptacle between the flange cover and the flange platform, the flange receptacle configured to secure a button during application of the button-tag assembly; and
a tag holder arm comprising:
a second handle; and
a second jaw, the second jaw having a tag receptacle, the tag receptacle configured to secure a tag during application of the button-tag assembly;
wherein the button holder arm and the tag holder arm are pivotally engaged at a hinge point such that the button holder arm and tag holder arm may pivot relative to each other between the open position and the closed position.

31. The button applicator of claim 30, wherein the button holder arm further comprises a first hinge portion between the first handle and the first jaw; wherein the tag holder arm further comprises a second hinge portion between the second handle and the second jaw; and wherein the first hinge portion is pivotally engaged with the second hinge portion.

32. The button applicator of claim 31, wherein the button holder arm is integrally formed of entirely a first material; and wherein the tag holder arm is integrally formed entirely of the first material.

33. The button applicator of claim 31, wherein the flange platform further comprises a magnet configured to engage the button.

34. The button applicator of claim 30, wherein each of the flange cover and the tag receptacle are U-shaped.

35. A kit for applying a button-tag assembly to an animal, the kit comprising:
a button-tag assembly comprising:
a tag; and
a button, the button comprising:
a button body, the button body comprising:
a button back, the button back having a front surface and a rear surface and the rear surface of the button back forming a proximal end of the button;
a button shaft extending from the front surface of the button back, the button shaft having a proximal end engaged with the button back and a distal end; and
a button head extending from the distal end of the button shaft, the button head having a proximal end engaged with the distal end of the button shaft and a distal end;
a core embedded within the button body and extending from the distal end of the button head, the core comprising:
a core shaft having a proximal end and a distal end, the core shaft extending through at least a portion of the button head and the button shaft; and
a core head extending from the distal end of the core shaft and extending from the distal end of the button head, the core head forming a core tip at the distal end of the button; and
a button applicator pivotable between an open position and a closed position and configured to apply the button-tag assembly to an animal, the button applicator comprising:
a button holder arm comprising:
a first handle; and
a first jaw, the first jaw having a flange platform, the button configured to engage the flange platform during application of the button-tag assembly; and
a tag holder arm comprising:
a second handle; and
a second jaw, the second jaw having a tag receptacle, the tag receptacle configured to secure a tag during application of the button-tag assembly;
wherein the button holder arm and the tag holder arm are pivotally engaged at a hinge point such that the button holder arm and tag holder arm may pivot relative to each other between the open position and the closed position.

36. The kit of claim 35, wherein the button is substantially free of any voids.

37. The kit of claim 35, wherein the core tip comprises a bladed edge.

38. The kit of claim 37, wherein the bladed edge forms a ridge along the distal end of the button.

39. The kit of claim 35, wherein the core extends entirely through each of the button back, the button shaft, and the button head.

40. The button of claim 35, wherein the proximal end of the core shaft is flush with the rear surface of the button back.

41. The kit of claim 35, wherein the lower jaw further comprises a rear wall extending upward from the flange platform, and a U-shaped flange cover extending outward from the rear wall forming a button flange receptacle between the flange cover and the flange platform, the flange receptacle configured to secure a button during application of the button-tag assembly.

42. A method for applying a button-tag assembly to an animal, the method comprising:
providing a button-tag assembly, the button-tag assembly comprising:
a tag; and
a button, the button comprising:
a button body, the button body comprising:
a button back, the button back having a front surface and a rear surface and the rear surface of the button back forming a proximal end of the button;
a button shaft extending from the front surface of the button back, the button shaft having a proximal end engaged with the button back and a distal end;
a button head extending from the distal end of the button shaft, the button head having a proximal end engaged with the distal end of the button shaft and a distal end; and
a core head extending from the distal end of the button head, the core head forming a core tip at the distal end of the button;
providing a button applicator movable between an open position and a closed position and configured to apply the button-tag assembly to an animal, the button applicator comprising:
a first jaw having a flange platform, the button configured to engage the flange platform during application of the button-tag assembly; and
a second jaw having a tag receptacle, the tag receptacle configured to secure a tag during application of the button-tag assembly;
engaging the button with the first jaw;
engaging the tag with the second jaw; and
moving the button applicator to the closed position so as to engage the button with the tag.

43. The method of claim 42, wherein the button is substantially free of any voids.

44. The method of claim 42, wherein the core tip comprises a bladed edge.

45. The method of claim 42, wherein the button further comprises a core shaft having a proximal end and a distal end, the core shaft embedded within the button body and engaged at the distal end of the core shaft with the core head.

46. The method of claim 45, wherein the core shaft extends through at least a portion of the button head and the button shaft.

47. A button for an animal identification tag comprising:
a body comprising a flat back portion, a conical head portion, and a shaft portion extending between the flat back portion and the conical head portion; and
a solid core comprising a core shaft embedded in the shaft portion of the body and a core head extending away from the conical head portion of the body, the core head comprising a bladed edge.

48. A method for applying a button-tag assembly to an animal, the method comprising:
engaging a tag with a first jaw of a button applicator movable between an open position and a closed position;
engaging a button with a second jaw of the button applicator, the button comprising:
a body comprising a flat back portion, a conical head portion, and a shaft portion extending between the flat back portion and the conical head portion; and
a solid core comprising a core shaft embedded in the shaft portion of the body and a core head extending away from the conical head portion of the body, the core head comprising a bladed edge;
positioning an ear of the animal between the first jaw and the second jaw while the button applicator is at the open position;
moving the button applicator from the open position to the closed position so as to engage the button with the tag wherein the bladed edge forms an incision through the ear of the animal as the button applicator moves from the open position to the closed position; and
moving the button applicator in a direction away from the ear of the animal so as to disengage the button-tag assembly from the button applicator.
